(19) United States
(12) Patent Application Publication
(10) Pub. No.: US 2026/0002599 A1
(43) Pub. Date: Jan. 1, 2026

(54) ASSEMBLY FOR CONTROLLING FLUID FLOW AND METHOD OF MAKING THE ASSEMBLY

(71) Applicant: The Lee Company, Westbrook, CT (US)

(72) Inventors: Pavel Grigorash, New London, CT (US); Joseph Riccitelli, Deep River, CT (US)

(21) Appl. No.: 19/242,526

(22) Filed: Jun. 18, 2025

Related U.S. Application Data
(60) Provisional application No. 63/665,486, filed on Jun. 28, 2024.
(60) Provisional application No. 63/665,925, filed on Jun. 28, 2024.
(60) Provisional application No. 63/754,196, filed on Feb. 5, 2025.

(51) Int. Cl. F16K 15/02; F16K 27/02

(52) U.S. Cl. CPC F16K 15/028; F16K 27/0209

(57) ABSTRACT

An assembly for limiting fluid flow in a conduit, including: a body defining an inner cavity, the body having a wall portion that extends from an end portion of the body, the wall portion and the end portion defining the inner cavity, the wall portion having an outwardly flared portion that extends away from the inner cavity at an open end of the body, the open end being opposite to the end portion of the body, the wall portion having a crimp proximate to the outwardly flared portion, the crimp extends towards the inner cavity; and a fluid flow restricting member retained within the inner cavity of the body, wherein the fluid flow restricting member reduces or prevents fluid flow through the inner cavity and the crimp prevents the fluid flow restricting member from being removed from the inner cavity.

### CROSS REFERENCE TO RELATED APPLICATIONS

This application claims priority to the following applications: U.S. Provisional Patent Application No. 63/665,486 filed on Jun. 28, 2024; U.S. Provisional Patent Application No. 63/665,925 filed on Jun. 28, 2024 and U.S. Provisional Patent Application No. 63/754,196 filed on Feb. 5, 2025, the entire contents each of which are incorporated herein by reference thereto.

### BACKGROUND

Exemplary embodiments of the present disclosure pertain to the art of fluid flow restriction control assemblies and methods of making.

Assemblies for fluid flow control whether they be valves, flow restrictors or variable flow restrictors require at least two components that must be assembled together. The assemblies include at least one input opening and at least one output opening that are in fluid communication with each other and there must be a means for retaining the components together while still providing for the fluid communication between the at least one input opening and at least one output opening.

Accordingly, there is a desire to provide a method and apparatus for controlling fluid flow through the assembly.

### BRIEF DESCRIPTION

Disclosed is an assembly for limiting fluid flow in a conduit, including: a body defining an inner cavity, the body having a wall portion that extends from an end portion of the body, the wall portion and the end portion defining the inner cavity, the wall portion having an outwardly flared portion that extends away from the inner cavity at an open end of the body, the open end being opposite to the end portion of the body, the wall portion having a crimp proximate to the outwardly flared portion, the crimp extends towards the inner cavity; and a fluid flow restricting member retained within the inner cavity of the body, wherein the fluid flow restricting member reduces or prevents fluid flow through the inner cavity and the crimp prevents the fluid flow restricting member from being removed from the inner cavity.

In addition to one or more of the features described above, or as an alternative to any of the foregoing embodiments, the body is a cylindrical member, the wall portion having an inner diameter defining the inner cavity and an outer diameter defining an outer periphery of the body, the outwardly flared portion defining an outermost dimension of the outer diameter and the crimp defining an innermost dimension of the inner diameter.

In addition to one or more of the features described above, or as an alternative to any of the foregoing embodiments, the outwardly flared portion and the crimp are formed in the body after the fluid flow restricting member is inserted into the inner cavity.

In addition to one or more of the features described above, or as an alternative to any of the foregoing embodiments, the crimp extends completely about the inner diameter and the outwardly flared portion extends completely about the outer diameter.

In addition to one or more of the features described above, or as an alternative to any of the foregoing embodiments, the fluid flow restricting member is movably retained within the inner cavity of the body for movement between a first position where the fluid flow restricting member reduces or prevents fluid flow through the inner cavity and at least a second position where fluid flow through the inner cavity is greater than when the fluid flow restricting member is in the first position and the crimp defines a limit of movement of the fluid flow restricting member away from the first position.

In addition to one or more of the features described above, or as an alternative to any of the foregoing embodiments, the fluid flow restricting member is movably retained within the inner cavity of the body for movement between a first position where the fluid flow restricting member reduces or prevents fluid flow through the inner cavity and at least a second position where fluid flow through the inner cavity is greater than when the fluid flow restricting member is in the first position and the assembly further including a stop member located between the crimp and the fluid flow restricting member, the stop member defining a limit of movement of the fluid flow restricting member away from the first position.

In addition to one or more of the features described above, or as an alternative to any of the foregoing embodiments, the fluid flow restricting member is movably retained within the inner cavity of the body for movement between a first position where the fluid flow restricting member reduces or prevents fluid flow through the inner cavity and at least a second position where fluid flow through the inner cavity is greater than when the fluid flow restricting member is in the first position and the crimp defines the second position of the fluid flow restricting member.

In addition to one or more of the features described above, or as an alternative to any of the foregoing embodiments, the fluid flow restricting member is movably retained within the inner cavity of the body for movement between a first position where the fluid flow restricting member reduces or prevents fluid flow through the inner cavity and at least a second position where fluid flow through the inner cavity is greater than when the fluid flow restricting member is in the first position and the assembly further including: a biasing member contacting and retaining the fluid flow restricting member in the first position; and a stop member located between the crimp and the biasing member, the stop member providing a reaction surface for the biasing member and the crimp retaining the stop member, the biasing member and the fluid flow restricting member in the inner cavity.

In addition to one or more of the features described above, or as an alternative to any of the foregoing embodiments, the end portion of the body has an opening that is at least partially sealed by the fluid flow restricting member when the fluid flow restriction member is in the first position.

In addition to one or more of the features described above, or as an alternative to any of the foregoing embodiments, the end portion of the body has an opening that is completely sealed by the fluid flow restricting member when the fluid flow restriction member is in the first position.

In addition to one or more of the features described above, or as an alternative to any of the foregoing embodiments, the fluid flow restricting member is movably retained within the inner cavity of the body for movement between a first position where the fluid flow restricting member reduces or prevents fluid flow through the inner cavity and at least a second position where fluid flow through the inner cavity is greater than when the fluid flow restricting member is in the first position.

In addition to one or more of the features described above, or as an alternative to any of the foregoing embodiments, the assembly further includes: a stop member located between the crimp and the fluid flow restricting member, the stop member providing a reaction surface for the fluid flow restricting member and the crimp retaining the stop member and the fluid flow restricting member in the inner cavity.

In addition to one or more of the features described above, or as an alternative to any of the foregoing embodiments, the fluid flow restricting member is movably retained within the inner cavity of the body for movement between a first position where the fluid flow restricting member reduces or prevents fluid flow through the inner cavity and at least a second position where fluid flow through the inner cavity is greater than when the fluid flow restricting member is in the first position and the end portion of the body has an opening that is at least partially sealed by the fluid flow restricting member when the fluid flow restriction member is in the first position.

In addition to one or more of the features described above, or as an alternative to any of the foregoing embodiments, the fluid flow restricting member has at least one opening that is smaller than the opening in the end portion, the at least one opening allowing fluid flow through the inner cavity when the fluid flow restriction member is in the first position.

In addition to one or more of the features described above, or as an alternative to any of the foregoing embodiments, the fluid flow restricting member is movably retained within the inner cavity of the body for movement between a first position where the fluid flow restricting member reduces or prevents fluid flow through the inner cavity and at least a second position where fluid flow through the inner cavity is greater than when the fluid flow restricting member is in the first position and the end portion of the body has an opening that is completely sealed by the fluid flow restricting member when the fluid flow restriction member is in the first position.

In addition to one or more of the features described above, or as an alternative to any of the foregoing embodiments, an inner diameter of the conduit is less than the outermost dimension of the outer diameter such that the outwardly flared portion retains the assembly in the conduit by frictionally engaging an inner surface of the inner diameter of the conduit when the assembly is inserted into the conduit.

In addition to one or more of the features described above, or as an alternative to any of the foregoing embodiments, the outermost dimension of the body is in a range of 3 mm to 30 mm, and the innermost dimension being in a range of 3 mm to 30 mm.

In addition to one or more of the features described above, or as an alternative to any of the foregoing embodiments, the outwardly flared portion is located at a distal end of the body.

In addition to one or more of the features described above, or as an alternative to any of the foregoing embodiments, the body is a cylindrical member, the wall portion having a first inner diameter ID-1 defining the inner cavity and a first outer diameter OD-1 defining an outer periphery of the body, the outwardly flared portion defining a second outer diameter OD-2 defining an outermost diameter of the body and the crimp defining a second inner diameter ID-2 defining an innermost diameter of the inner cavity, the first inner diameter ID-1 being greater than the second inner diameter ID-2 and the first outer diameter OD-1 being less than the second outer diameter OD-2.

In addition to one or more of the features described above, or as an alternative to any of the foregoing embodiments, the first outer diameter OD-1 to the second outer diameter OD-2 has a ratio of up to 2:3 and the first outer diameter OD-1 to the second inner diameter ID-2 has a ratio of up to 2:1.

In addition to one or more of the features described above, or as an alternative to any of the foregoing embodiments, a range of the first outer diameter OD-1, the second outer diameter OD-2, the first inner diameter ID-1 and the second inner diameter ID-2 are 3 mm to 30 mm.

Also disclosed is a valve assembly, including: a body defining an inner cavity, the body having a wall portion extending from an end portion of the body, the wall portion and the end portion defining the inner cavity, the wall portion having an outwardly flared portion that extends away from the inner cavity at an open end of the body, the open end being opposite to the end portion of the body, the wall portion having a crimp proximate to the outwardly flared portion, the crimp extends towards the inner cavity; a poppet movably retained within the inner cavity of the body for movement between a first position where the poppet seals an opening in the end portion of body and at least a second position where the opening in the end portion of body is not sealed by the poppet; a biasing member maintaining the poppet in the first position; and a stop member located between the crimp and the biasing member, the stop member providing a reaction surface for the biasing member and the crimp retaining the stop member in the inner cavity.

In addition to one or more of the features described above, or as an alternative to any of the foregoing embodiments, the poppet has a nose portion that seals the opening in the end portion of the body when the poppet is in the first position, the poppet further including a plurality of members that extend from the nose portion to a ring portion, the plurality of members define a plurality of openings that provide fluid communication between the inner cavity and the opening in the end portion of the body when the poppet is in the second position.

In addition to one or more of the features described above, or as an alternative to any of the foregoing embodiments, the nose portion has a frustoconical shape that extends through the opening in the end portion of the body when the poppet is in the first position.

Also disclosed is a method for forming an assembly for limiting fluid flow in a conduit, including: inserting a fluid flow restricting member into an inner cavity of a body of the assembly; crimping a wall of the body to define a crimp that extends into the inner cavity in order to retain the fluid flow restricting member in the inner cavity of the body; flaring the wall of the body to define an outwardly flared portion that extends away from the inner cavity, the flaring step being performed after the crimping step, the fluid flow restricting member reduces or prevents fluid flow through the inner cavity.

In addition to one or more of the features described above, or as an alternative to any of the foregoing embodiments, the fluid flow restricting member is movably retained within the inner cavity of the body for movement between a first position where the fluid flow restricting member reduces or prevents fluid flow through the inner cavity and at least a second position where fluid flow through the inner cavity is greater than when the fluid flow restricting member is in the first position.

### BRIEF DESCRIPTION OF THE DRAWINGS

The following descriptions should not be considered limiting in any way. With reference to the accompanying drawings, like elements are numbered alike:

FIG. 1 is a perspective cross-sectional view of an assembly in accordance with the present disclosure;

FIG. 2 is a cross-sectional view of an assembly in accordance with the present disclosure;

FIG. 3 is a cross-sectional view of an assembly inserted into a conduit in accordance with the present disclosure;

FIG. 4 is a cross-sectional view of an assembly according to another embodiment in a first position in accordance with the present disclosure;

FIG. 5 is a cross-sectional view of the assembly illustrated in FIG. 4 in a second or another position in accordance with the present disclosure;

FIG. 6 is a top view of an assembly of the present disclosure inserted into a conduit in accordance with the present disclosure;

FIG. 7 is a view along lines 7-7 of FIG. 6 in a first position in accordance with the present disclosure;

FIG. 8 is a top view of an assembly of the present disclosure inserted into a conduit in accordance with the present disclosure;

FIG. 9 is a view along lines 9-9 of FIG. 8 in a second or another position in accordance with the present disclosure;

FIG. 10 is a cross-sectional view of an alternative configuration in accordance with the present disclosure;

FIG. 11 is a cross-sectional view of the assembly inserted into a wall of a housing;

FIG. 12A is a cross-sectional view of a portion of a body prior to a forming process in accordance with the present disclosure;

FIG. 12B is a cross-sectional view of a portion of the assembly illustrated in at least FIG. 2; and

FIGS. 13-15 illustrate a tool and method for forming the assembly in accordance with the present disclosure.

### DETAILED DESCRIPTION

A detailed description of one or more embodiments of the disclosed apparatus and method are presented herein by way of exemplification and not limitation with reference to the Figures.

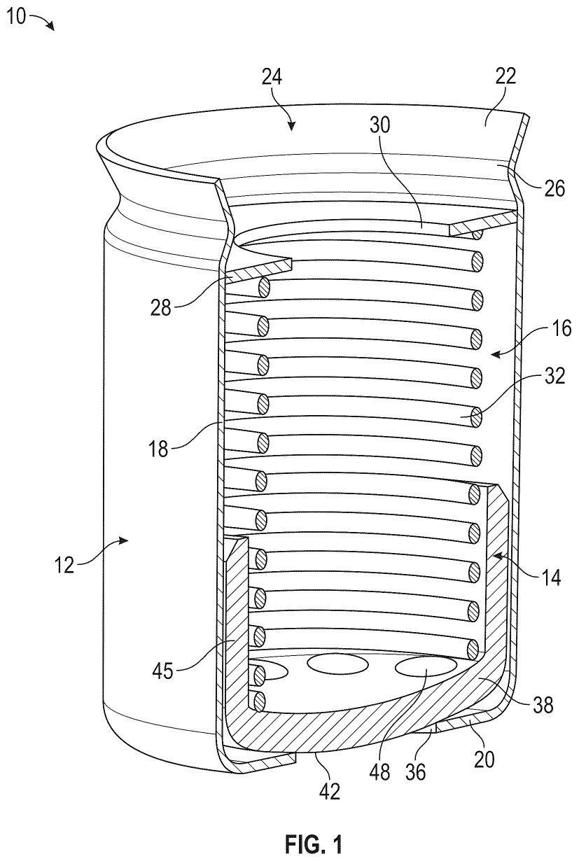

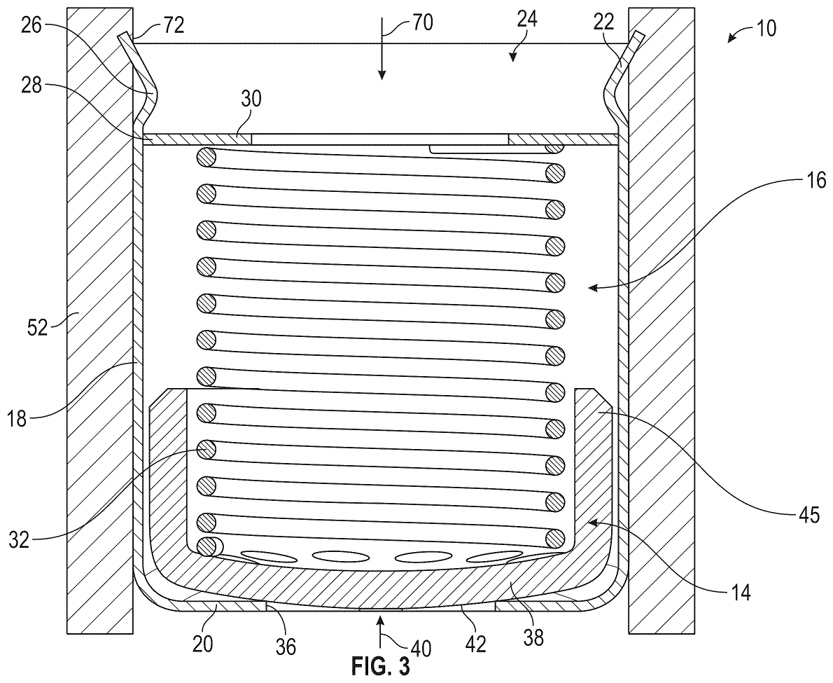

Referring now to at least FIGS. 1-3, an assembly 10 of the present disclosure is illustrated. As used herein “assembly” refers to at least two components assembled together in accordance with present disclosure. The assembly defines a fluid flow path through the assembly which may be restricted, closed or opened depending on conditions on opposite ends of the fluid flow path through the assembly. In other words and as discussed herein, the assembly may be a fluid flow restrictor that allows a limited amount of fluid flow in a first condition or first position and a greater amount of fluid flow in a second condition or second position. In one embodiment, the first condition or first position may always allow some amount of fluid flow through the assembly or alternatively the first condition or first position may prevent any fluid flow. As used herein “fluid” is intended to cover any liquid, gas or any other material that can flow or combinations thereof that may continuously move or deform under an applied shear stress or external force.

In accordance with various embodiments of the present disclosure, the assembly 10 includes a body 12 and a fluid flow restricting member 14. The body defines an inner cavity 16. The body 12 has a wall portion 18 that extends from an end portion 20 of the body 12. The wall portion 18 and the end portion 20 defining the inner cavity 16. The wall portion 18 having an outwardly flared portion 22 that extends away from the inner cavity 16 at an open end 24 of the body 12. In one embodiment, the outwardly flared portion 22 is located at a distal end of the wall portion 18 of the body 12.

The open end 24 being opposite to the end portion 20 of the body 12. The wall portion 18 having at least one crimp 26 or a plurality of crimps 26 proximate to the outwardly flared portion 22, the least one crimp 26 or plurality of crimps 26 extend towards the inner cavity 16. In other words, the outwardly flared portion 22 and the least one crimp or plurality of crimps 26 extend in opposite directions.

In accordance with various non-limiting embodiments of the present disclosure, the body 12 comprising the wall portion 18 and/or the end portion 20 defines a cylindrical or generally cylindrical body. In accordance with one non-limiting embodiment of the present disclosure the body 12 comprising the wall portion 18 and/or the end portion 20 is formed from metal or an alloy such as steel or stainless steel. Of course, other materials are contemplated to be within the scope of the present disclosure as long as they are capable of being deflected and formed as described herein.

In accordance with various non-limiting embodiments of the present disclosure, a plurality of separate crimps 26 are provided in the wall portion 18 or the crimp is a single crimp 26 that circumscribes or extends about the inner periphery of the inner cavity defined by the wall portion 18.

In accordance with various embodiments of the present disclosure the fluid flow restricting member 14 is moveably received within the inner cavity 16 for movement between at least a first position where the fluid flow restricting member 14 reduces or prevents fluid flow through the inner cavity 16 and a second position where the fluid flow restricting member 14 allows or increases a fluid flow through the inner cavity 16.

In accordance with various embodiments of the present disclosure the least one crimp 26 or the plurality of crimps 26 are formed in the wall portion 18 of the body 12 after the fluid flow restricting member 14 is inserted into the inner cavity 16. The at least one crimp 26 or plurality of crimps 26 extend into the inner cavity 16 and the fluid flow restricting member 14 and the at least one crimp 26 or the plurality of crimps 26 prevent the fluid flow restricting member 14 from being completely dislodged from the inner cavity 16 after the least one crimp 26 or the plurality of crimps 26 are formed in the wall portion 18 of the body 12.

In one non-limiting embodiment of the present disclosure, the fluid flow restricting member 14 is retained in the inner cavity 16 by a stop member 28 that is also inserted into the inner cavity 16 prior to the forming of the least one crimp 26 or the plurality of crimps 26 in the wall portion 18 of the body 12. In one non-limiting embodiment, the stop member 28 is a circular member or disc having an outer dimension or diameter that is slightly less than an inner dimension or diameter of the inner cavity and the stop member 28 has at least one inner opening 30 to allow fluid flow therethrough.

In one non-limiting embodiment of the present disclosure, the fluid flow restricting member 14 is biased into the first condition or first position by a biasing member or spring 32. Alternatively, the fluid flow restricting member 14 may held in the first condition or first position by only a pressure differential on opposite sides of the fluid flow restricting member 14 or a combination of the pressure differential on opposite sides of the fluid flow restricting member 14 and the biasing force of the biasing member or spring 32. In either case and in one non-limiting embodiment of the present disclosure, the stop member 28 provides a reaction surface 34 for the biasing member or spring 32 in the assembly 10 with the biasing member or spring 32 or a reaction surface 34 for the fluid flow restricting member 14 in the assembly 10 without the biasing member or spring 32.

As illustrated, the end portion 20 of the body 12 includes an opening 36. The opening 36 is in one embodiment formed in the end portion 20 by a coining process or step. The opening 36 is configured to be sealed or partially closed by the fluid flow restricting member 14 when the fluid flow restricting member 14 is in the first position or first condition.

In one non-limiting embodiment, the fluid flow restricting member 14 completely seals opening 36 when it is in the first position. For example and as illustrated in at least FIGS. 1-3, the fluid flow restricting member 14 has a sealing portion or nose portion 38 that completely seals opening 36 when the fluid flow restricting member 14 is in the first position.

In one embodiment, and when the assembly 10 does not include a biasing member or spring 32, the fluid flow restricting member 14 is retained in the first position or moved from the first position toward the second position and vice versa by a difference in fluid flow pressures acting upon opposite sides of the fluid flow restricting member 14.

For example, and when a fluid flow pressure or difference in fluid pressure, delta P (ΔP) acting on a side of the end portion 20 that is opposite to the inner cavity 16 is greater than the fluid flow pressure or difference in fluid pressure, delta P (ΔP) acting on a side of the end portion 20 that faces the inner cavity 16, the fluid flow restricting member 14 will move in the direction of arrow 40 away from the first position such that the sealing portion or nose portion 38 is no longer seated about opening 36. In other words, the sealing portion or nose portion 38 of the fluid flow restricting member 14 has a contact surface 42 that seals opening 36 when the fluid flow restricting member 14 is in the first position. In one non-limiting embodiment, the contact surface 42 has a curved surface in order assist with the sealing of opening 36 when the fluid flow restricting member 14 is in the first position.

Conversely, and when a fluid flow pressure or difference in fluid pressure, delta P (ΔP) acting on a side of the end portion 20 that is opposite to the inner cavity 16 is lesser than the fluid flow pressure or difference in fluid pressure, delta P (ΔP) acting on a side of the end portion 20 that faces the inner cavity 16, the fluid flow restricting member 14 will move in the direction of arrow 44 towards the first position such that the sealing portion or nose portion 38 is seated about opening 36. In other words, the sealing portion or nose portion 38 of the fluid flow restricting member 14 has a contact surface 42 that seals opening 36 when the fluid flow restricting member 14 is in the first position. For example, and when the fluid flow restricting member 14 is in a second position or any position other than the first position when the sealing portion or nose portion 38 is not seated about opening 36 and the aforementioned differences in fluid flow pressures occurs on opposite sides of the sealing portion or nose portion 38 the fluid flow restricting member 14 will be moved from a position or second position where fluid flow is allowed through the assembly 10 to the first position where the sealing portion or nose portion 38 is seated about opening 36.

As previously mentioned and in one non-limiting embodiment, the fluid flow restricting member 14 is retained the first position by a biasing force of spring or biasing member 32 in the direction of arrow 44. In this embodiment, and in order to move the fluid flow restricting member 14 in the direction of arrow 42 away from the first position, the fluid flow pressure or difference in fluid pressure, delta P (ΔP) acting on a side of the end portion 20 that is opposite to the inner cavity 16 must be greater than the fluid flow pressure or difference in fluid pressure, delta P (ΔP) acting on a side of the end portion 20 that faces the inner cavity 16 and the biasing force of the spring or biasing member 32 in the direction of arrow 44.

In one non-limiting embodiment, the fluid flow restricting member 14 has a wall portion 45 of the fluid flow restricting member 14 that defines a cavity 46 for retaining a portion of the biasing member therein. In one embodiment, the sealing portion or nose portion 38 has at least one or a plurality of openings 48 that provide a fluid path through the assembly 10 when the fluid flow restricting member 14 is moved away from the first position in the direction of arrow 40.

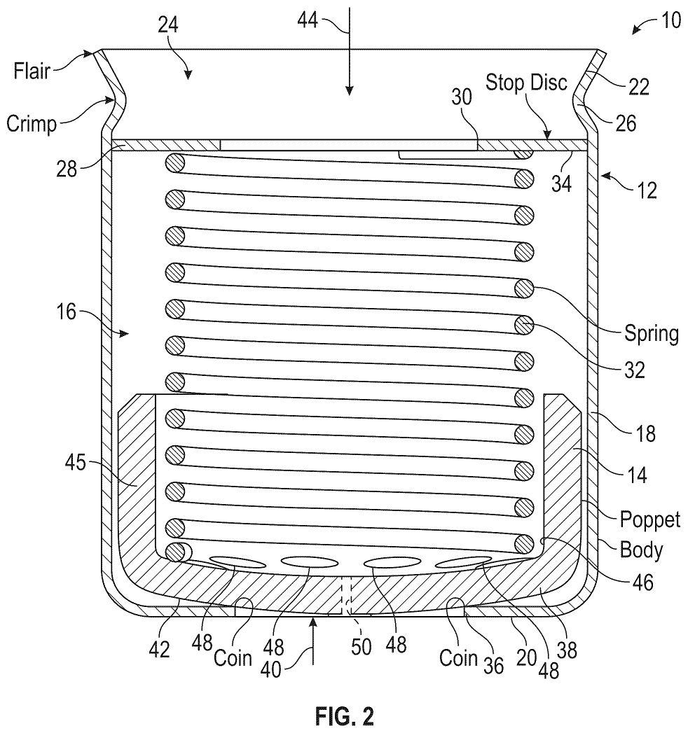

Alternatively and as illustrated by the dashed lines in FIG. 2, the sealing portion or nose portion 38 may have an opening 50 or a plurality of openings 50 extending therethrough. In this embodiment, the opening 50 or plurality of openings 50 always provide a fluid flow path through the sealing portion or nose portion 38 regardless of the position of the fluid flow restricting member 14. In other words, the assembly 10 may be referred to as a flow restricting assembly 10 while there is always a flow through the assembly 10 (e.g., a smaller flow rate when the fluid flow restricting member 14 is in the first position and a larger flow rate when the fluid flow restricting member 14 is moved away from the first position towards the second position as there is also a fluid flow through the at least one opening or openings 48 when the fluid flow restricting member 14 is moved away from the first position towards the second position).

Alternatively and as previously mentioned, the fluid flow restricting member 14 in one embodiment does not have opening 50 or a plurality of openings 50. As such and in this embodiment, the fluid flow through the assembly 10 only occurs when the when the fluid flow restricting member 14 is in the second position when the fluid flow restricting member 14 is moved away from the first position towards the second position. In this embodiment, the assembly 10 may be referred to a valve or valve assembly.

As mentioned above, the wall portion 18 has an outwardly flared portion 22 that extends away from the inner cavity 16 at an open end 24 of the body 12. The outwardly flared portion 22 circumscribes the entire periphery of the open end 24 of the body 12 and the outwardly flared portion 22 extends furthest from the wall portion 18. This allows the outwardly flared portion 22 to retain the assembly 10 in a conduit or hose 52 or an opening 54 in a wall 56 (see FIG. 11) of a housing 58 that defines a cavity 60 of the housing 58. As such, the assembly 10 when inserted into the conduit or hose 52 or opening 54 in wall 56 in the direction of arrows 70 an outermost edge of the outwardly flared portion 22 will engage a surface 72 of the conduit or hose 52 or opening 54 in wall 56 in order to retain the assembly 10 in conduit or hose 52 or opening 54 in wall 56. In one embodiment, the conduit or hose 52 is made of rubber, plastic, nylon or any material of being engaged by the outermost edge of the outwardly flared portion 22 when it is inserted therein.

As illustrated, the body 12 and/or the end portion 20 that defines a cylindrical or generally cylindrical body 12 has a dimension that is slightly less than a diameter of the conduit or hose 52 or opening 54 in wall 56 such that the assembly 10 can be inserted slide therein in the direction of arrow 70 and then the outermost edge of the outwardly flared portion 22 will engage surface 72 of the conduit or hose 52 or opening 54 in wall 56 in order to retain the assembly 10 in its desired location withing the conduit or hose 52 or opening 54 in wall 56 as fluid flow pressures on opposite sides of the assembly vary thus preventing it from being removed from the conduit or hose 52 or opening 54 in wall 56 in a direction opposite to arrow 70. In other words, the outermost edge of the outwardly flared portion 22 will allow for movement in the direction of arrow 70 but prevent movement in a direction opposite to arrow 70 once the assembly is in it desired location within conduit or hose 52 or opening 54 in wall 56.

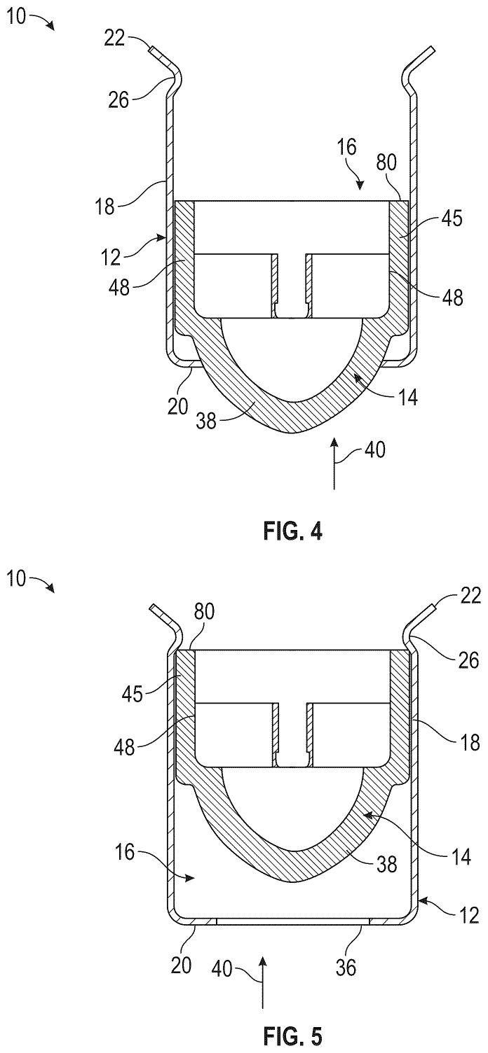

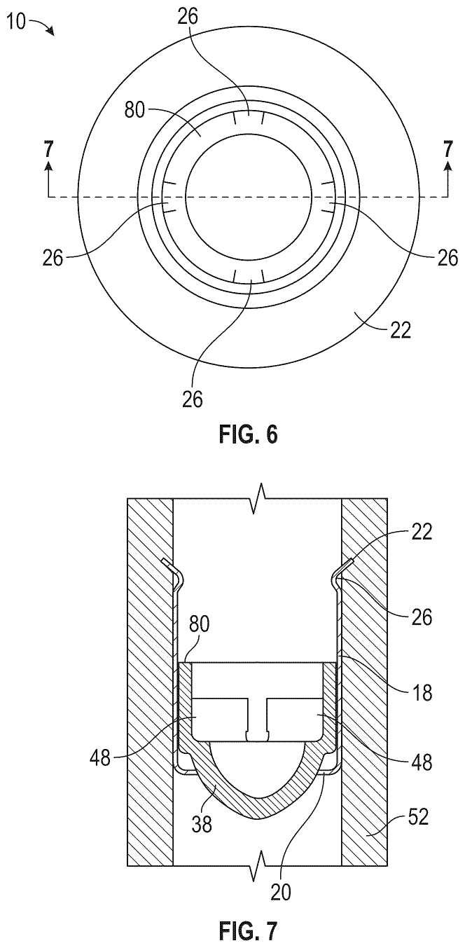

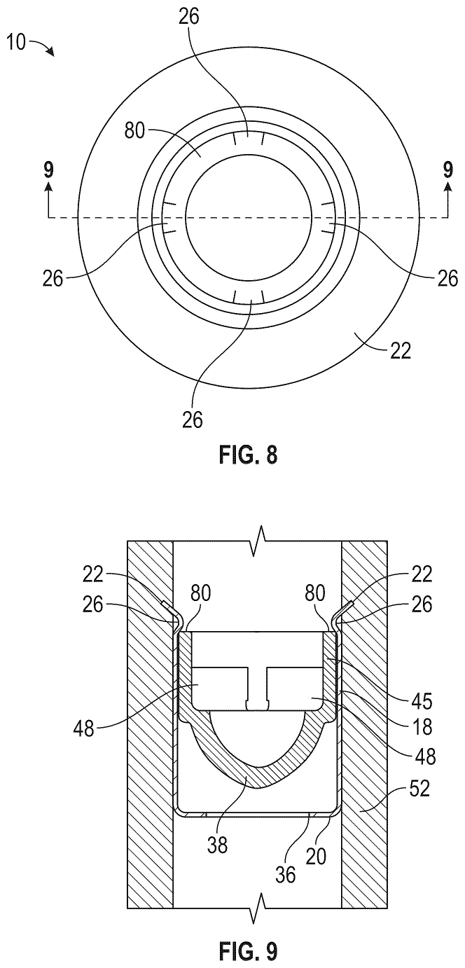

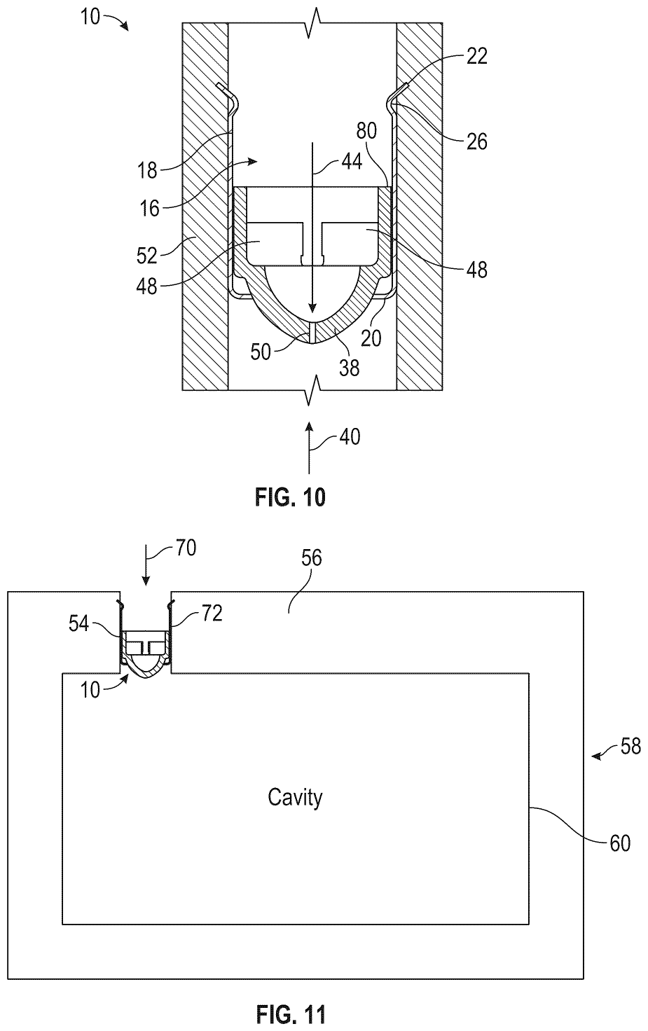

Referring now to FIGS. 4-10, an alternative configuration of the assembly 10 is illustrated. Here the sealing portion or nose portion 38 of the fluid flow restricting member 14 has an extending portion or frustoconical portion that extends through the opening 36 when the fluid flow restricting member 14 is in the first position. In addition, the openings 48 are located in the wall portion 45 of the fluid flow restricting member 14 such that the fluid flow restricting member 14 is moved in the direction of arrow 40 fluid flow through assembly 10 is possible via openings 48 and opening 36 and open end 24. In one embodiment, the fluid flow restricting member 14 may be referred to as a poppet.

FIGS. 4-10 illustrate that the crimp 26 provides the means for retaining the fluid flow restricting member 14 in the body 12. This is facilitated by the crimp 26 contacting a top 80 of wall 45. See at least FIG. 9. As such, and in one embodiment, the assembly 10 does not have a stop member 18. In addition and as illustrated in FIGS. 4-10 there is no biasing member or spring 32 and no opening 50 in sealing portion or nose portion 38. Of course, alternative configurations contemplate that the embodiment of at least FIGS. 4-10 may include any one of or any combination of biasing member or spring 32, stop member 18 and opening 50 in sealing portion or nose portion 38.

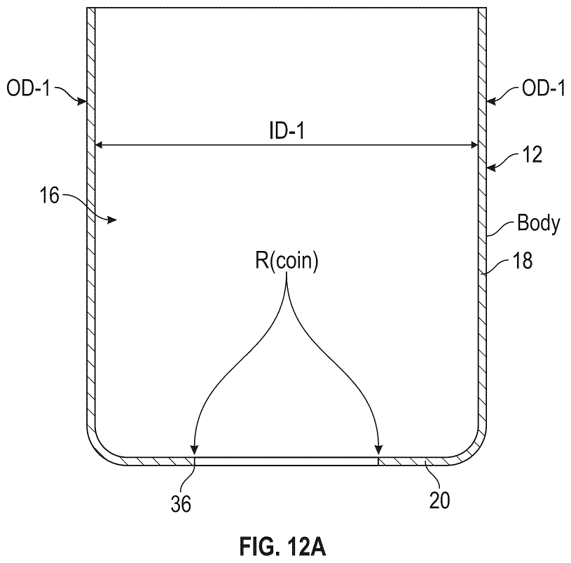

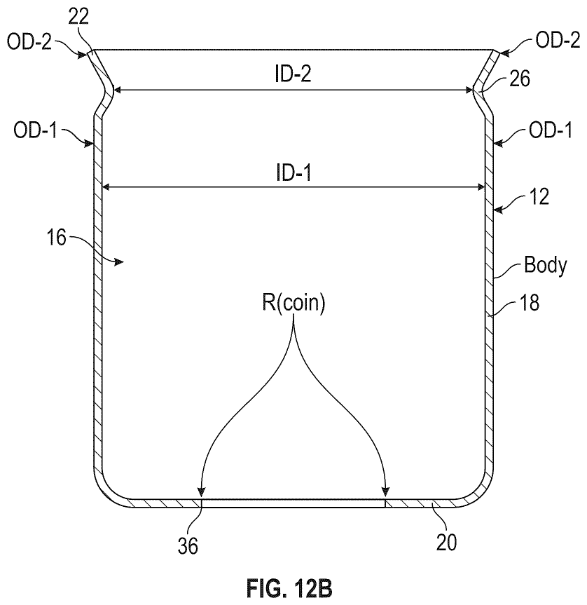

Referring now to FIG. 12A, the body 12 is illustrated prior to the forming of the crimp or crimps 26 and the outwardly flared portion 22. FIG. 12B illustrates the body 12 after the forming of the crimp or crimps 26 and the outwardly flared portion 22. As illustrated in at least FIGS. 12A and 12B, the body 12 and/or the end portion 20 define a cylindrical or generally cylindrical body 12 having a first inner diameter ID-1 and first outer diameter OD-1. FIG. 12B illustrates, the crimp or crimps 26 define a second inner diameter ID-2 and the outermost edge of the outwardly flared portion 22 defines a second outer diameter OD-2. The first inner diameter ID-1 is less than the second inner diameter ID-2 and the first outer diameter OD-1 is less than the second outer diameter OD-2.

In one embodiment the first outer diameter OD-1 to the second outer diameter OD-2 may have a ratio of up to 2:3 and the first outer diameter OD-1 to the second inner diameter ID-2 may have a ratio of up to 2:1. In addition and in one embodiment, a nominal diameter range of the aforementioned diameters may be in a range of 3 mm to 30 mm.

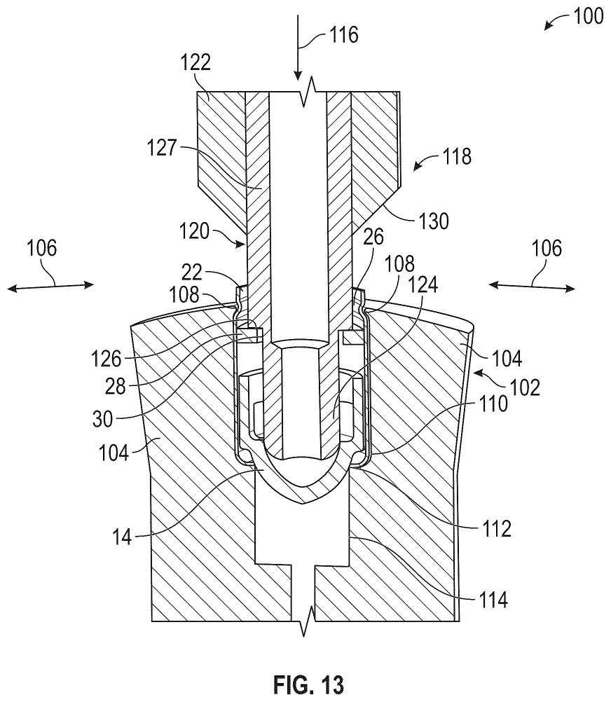

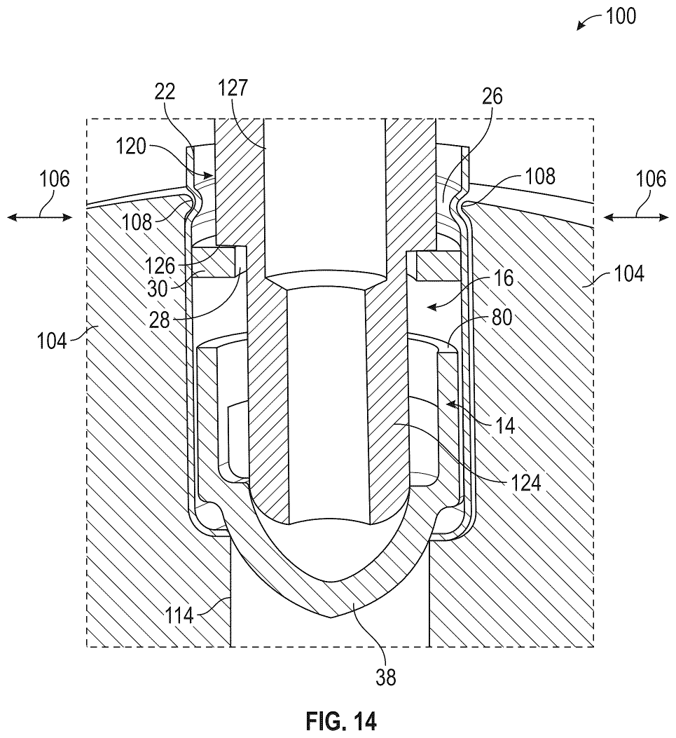

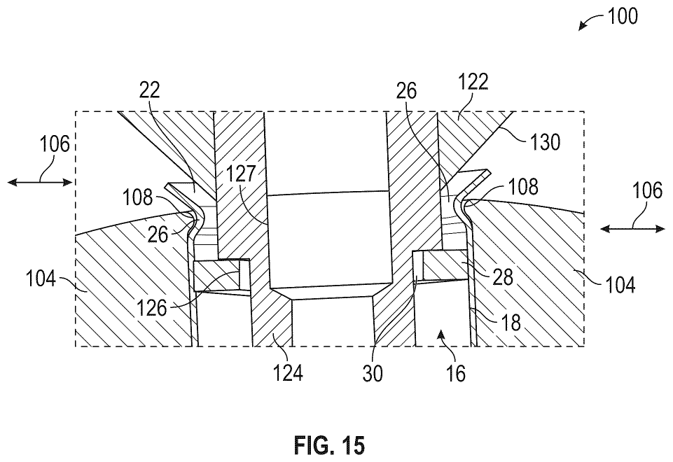

Referring now to FIGS. 13-15, a method for forming the assembly 10 and a tool 100 for forming the assembly 10 is illustrated. In general, the forming process serves at least two purposes: 1) retain the components of the assembly in the body (through crimp), and 2) forms a retention feature (through flare) to retain the product/assembly in a plastic housing, manifold or fitting. This retention feature may eliminate need for an extra component for retention of the assembly 10 in a conduit, hose, or wall.

The tool 100 has a crimping device or a collet crimping mechanism 102 for forming the crimp or crimps 26 in the body 12, the crimping device 102 has a plurality of members 104 that move in the direction of arrows 106 so that an edge 108 of the members 104 can form the crimp 26 in the body 12. The plurality of members 104 define a cavity 110 with a seat or edge 112 for receiving and engaging end 20 of the body 12. The crimping device 102 has a passage 114 for applying a suction force or vacuum in the direction of arrow 116 in order to retain the end 20 of body 12 against seat or edge 112. Alternatively and if applicable, no suction or vacuum force is applied to the body 12 when it is received in the cavity 110 and it is simply inserted therein either manually by hand or some form of automated process (e.g., robot etc.).

The body 12 is first inserted into the crimping device or a collet crimping mechanism 102 of tool 100 prior to the forming of the crimp 26. Thereafter, the fluid flow restricting member 14 and if applicable the spring or biasing member 32 and the stop member 28 are inserted into the inner cavity 16 by a second tool 118 or press station. Alternatively, the components may be inserted into inner cavity 16 by a hand or a combination of manual insertion and tool insertion. As previously noted and depending on the configuration of the assembly, the spring or biasing member 32 and the stop member 28 are optional components. It is also noted that, the spring or biasing member 32 is not illustrated in FIGS. 13-15, although it is contemplated that the spring or biasing member 32 may be inserted into the assembly 10.

As illustrated, the second tool 118 has an inner member 120 and an outer member 122, the inner member 120 and the outer member being slidable with respect to each other in the direction of arrow 116 and a direction opposite to arrow 116. The inner member 120 having a distal or front portion 124 for engaging and inserting the fluid flow restricting member 14 into the inner cavity 16 and a shoulder portion 126 for engaging and inserting the stop member 28 (if applicable) into the inner cavity 16.

In order to form the assembly 10, the body 12 is first inserted into the crimping device or collet crimping mechanism 102 prior to the forming of the crimp or crimps 26. Once the body 12 is inserted into the crimping device or collet crimping mechanism 102, the second tool 118 is used to grasp the fluid flow restricting member 14, the spring or biasing member 32 (if applicable) and the stop member 28 (if applicable) from a separate location via a vacuum force that is applied to an internal cavity 127 of the inner member 120 in a direction opposite to arrow 116. For example, the second tool 118 via the vacuum force in the internal cavity 127 of the inner member 120 is used to grasp at least the fluid flow restricting member 14 or a nest of the fluid flow restricting member 14, the spring or biasing member 32 (if applicable) and the stop member 28 (if applicable) via the vacuum force that is applied to an internal cavity 127 of the inner member 120 in a direction opposite to arrow 116. Once grasped, by the second tool 118 the fluid flow restricting member 14 or a nest of the fluid flow restricting member 14, the spring or biasing member 32 (if applicable) and the stop member 28 (if applicable) are moved from the separate location and then they are inserted into the inner cavity 16 of the body 12 which is in the cavity 110 crimping device or a collet crimping mechanism 102 until they are located below the location where the crimp or crimps 26 are to be formed by the plurality of members 104 of the crimping device 102.

Once the components (e.g., the fluid flow restricting member 14 or a nest of the fluid flow restricting member 14, the spring or biasing member 32 (if applicable) and the stop member 28 (if applicable)) are in their desired location in the inner cavity 16, the plurality of members 104 of the crimping device 102 are moved towards each other so that edge 108 of the members 104 of the crimping device 102 form the crimp 26 in the body 12.

Thereafter, the outer member 122 is moved with respect to the inner member 120 in the direction of arrow 116 until an angled portion 130 of the outer member engages an end of the wall portion 18 and forms the outwardly flared portion 22 by forcing or flaring the end of the wall portion 18 outwardly. The flaring of the wall portion 18 of the body 12 to define the outwardly flared portion 22 is performed after the crimping step. Once the forming process is complete, the plurality of members 104 are moved away from the body 12 and it is removed from the tool 100.

As such, an inexpensive dual-purpose retention feature is provided by using both a collet crimping mechanism and press station either simultaneously or in sequence during the assembly process of the assembly 10.

The assembly 10 retains the fluid flow restricting member 14 in the body 12 through the crimp or crimps 26 and the outwardly flared portion 22 forms a retention feature forms a retention feature to retain the assembly 10 in the plastic housing, hose, conduit, manifold or fitting where the assembly 10 is inserted.

As such, the components of the assembly 10 are assembled, crimped and flared at same operation.

In accordance with one embodiment, the body 18 is formed having a generally cylindrical shape with an open top and a hole at the bottom, the body further has a flared top, and a crimped region proximate the flared top. In one method the method include the following steps: securing a body (prior to crimping and flaring the body) in a tool, the body having the generally cylindrical shape with the open top and the hole at the bottom, the body further having a first inner diameter (ID-1) and a first outer diameter (OD-1); forming a crimp proximate the top of the body that follows the generally cylindrical shape of the body, the crimp having a second inner diameter (ID-2) that is less than ID-1; forming a flare at the top of the body that follows the generally cylindrical shape of the body, the flare having a second outer diameter (OD-2) that is greater than OD-1.

In another embodiment, the body 12 further includes a hole at the bottom of the body, which is formed by a coining step prior to the forming of the crimp and the flair.

The term “about” is intended to include the degree of error associated with measurement of the particular quantity based upon the equipment available at the time of filing the application. For example, “about” can include a range of +8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An assembly for limiting fluid flow in a conduit, comprising:
a body defining an inner cavity, the body having a wall portion that extends from an end portion of the body, the wall portion and the end portion defining the inner cavity, the wall portion having an outwardly flared portion that extends away from the inner cavity at an open end of the body, the open end being opposite to the end portion of the body, the wall portion having a crimp proximate to the outwardly flared portion, the crimp extends towards the inner cavity; and
a fluid flow restricting member retained within the inner cavity of the body, wherein the fluid flow restricting member reduces or prevents fluid flow through the inner cavity and the crimp prevents the fluid flow restricting member from being removed from the inner cavity.

2. The assembly as in claim 1, wherein the body is a cylindrical member, the wall portion having an inner diameter defining the inner cavity and an outer diameter defining an outer periphery of the body, the outwardly flared portion defining an outermost dimension of the outer diameter and the crimp defining an innermost dimension of the inner diameter.

3. The assembly as in claim 2, wherein the outwardly flared portion and the crimp are formed in the body after the fluid flow restricting member is inserted into the inner cavity.

4. The assembly as in claim 2, wherein the crimp extends completely about the inner diameter and the outwardly flared portion extends completely about the outer diameter.

5. The assembly as in claim 1, wherein the fluid flow restricting member is movably retained within the inner cavity of the body for movement between a first position where the fluid flow restricting member reduces or prevents fluid flow through the inner cavity and at least a second position where fluid flow through the inner cavity is greater than when the fluid flow restricting member is in the first position and the crimp defines a limit of movement of the fluid flow restricting member away from the first position.

6. The assembly as in claim 1, wherein the fluid flow restricting member is movably retained within the inner cavity of the body for movement between a first position where the fluid flow restricting member reduces or prevents fluid flow through the inner cavity and at least a second position where fluid flow through the inner cavity is greater than when the fluid flow restricting member is in the first position and the assembly further comprising a stop member located between the crimp and the fluid flow restricting member, the stop member defining a limit of movement of the fluid flow restricting member away from the first position.

7. The assembly as in claim 1, wherein the fluid flow restricting member is movably retained within the inner cavity of the body for movement between a first position where the fluid flow restricting member reduces or prevents fluid flow through the inner cavity and at least a second position where fluid flow through the inner cavity is greater than when the fluid flow restricting member is in the first position and the crimp defines the second position of the fluid flow restricting member.

8. The assembly as in claim 1, wherein the fluid flow restricting member is movably retained within the inner cavity of the body for movement between a first position where the fluid flow restricting member reduces or prevents fluid flow through the inner cavity and at least a second position where fluid flow through the inner cavity is greater than when the fluid flow restricting member is in the first position and the assembly further comprising:
a biasing member contacting and retaining the fluid flow restricting member in the first position; and
a stop member located between the crimp and the biasing member, the stop member providing a reaction surface for the biasing member and the crimp retaining the stop member, the biasing member and the fluid flow restricting member in the inner cavity.

9. The assembly as in claim 8, wherein the end portion of the body has an opening that is at least partially sealed by the fluid flow restricting member when the fluid flow restriction member is in the first position.

10. The assembly as in claim 8, wherein the end portion of the body has an opening that is completely sealed by the fluid flow restricting member when the fluid flow restriction member is in the first position.

11. The assembly as in claim 1, wherein the fluid flow restricting member is movably retained within the inner cavity of the body for movement between a first position where the fluid flow restricting member reduces or prevents fluid flow through the inner cavity and at least a second position where fluid flow through the inner cavity is greater than when the fluid flow restricting member is in the first position.

12. The assembly as in claim 11, wherein the assembly further comprises:
a stop member located between the crimp and the fluid flow restricting member, the stop member providing a reaction surface for the fluid flow restricting member and the crimp retaining the stop member and the fluid flow restricting member in the inner cavity.

13. The assembly as in claim 11, wherein the fluid flow restricting member is movably retained within the inner cavity of the body for movement between a first position where the fluid flow restricting member reduces or prevents fluid flow through the inner cavity and at least a second position where fluid flow through the inner cavity is greater than when the fluid flow restricting member is in the first position and the end portion of the body has an opening that is at least partially sealed by the fluid flow restricting member when the fluid flow restriction member is in the first position.

14. The assembly as in claim 13, wherein the fluid flow restricting member has at least one opening that is smaller than the opening in the end portion, the at least one opening allowing fluid flow through the inner cavity when the fluid flow restriction member is in the first position.

15. The assembly as in claim 1, wherein the fluid flow restricting member is movably retained within the inner cavity of the body for movement between a first position where the fluid flow restricting member reduces or prevents fluid flow through the inner cavity and at least a second position where fluid flow through the inner cavity is greater than when the fluid flow restricting member is in the first position and the end portion of the body has an opening that is completely sealed by the fluid flow restricting member when the fluid flow restriction member is in the first position.

16. The assembly as in claim 2, wherein an inner diameter of the conduit is less than the outermost dimension of the outer diameter such that the outwardly flared portion retains the assembly in the conduit by frictionally engaging an inner surface of the inner diameter of the conduit when the assembly is inserted into the conduit.

17. The assembly as in claim 1, wherein the outwardly flared portion is located at a distal end of the body.

18. The assembly as in claim 1, wherein the body is a cylindrical member, the wall portion having a first inner diameter ID-1 defining the inner cavity and a first outer diameter OD-1 defining an outer periphery of the body, the outwardly flared portion defining a second outer diameter OD-2 defining an outermost diameter of the body and the crimp defining a second inner diameter ID-2 defining an innermost diameter of the inner cavity, the first inner diameter ID-1 being greater than the second inner diameter ID-2 and the first outer diameter OD-1 being less than the second outer diameter OD-2.

19. A valve assembly, comprising:
a body defining an inner cavity, the body having a wall portion extending from an end portion of the body, the wall portion and the end portion defining the inner cavity, the wall portion having an outwardly flared portion that extends away from the inner cavity at an open end of the body, the open end being opposite to the end portion of the body, the wall portion having a crimp proximate to the outwardly flared portion, the crimp extends towards the inner cavity;
a poppet movably retained within the inner cavity of the body for movement between a first position where the poppet seals an opening in the end portion of body and at least a second position where the opening in the end portion of body is not sealed by the poppet;
a biasing member maintaining the poppet in the first position; and
a stop member located between the crimp and the biasing member, the stop member providing a reaction surface for the biasing member and the crimp retaining the stop member in the inner cavity.

20. A method for forming an assembly for limiting fluid flow in a conduit, comprising:
inserting a fluid flow restricting member into an inner cavity of a body of the assembly;
crimping a wall of the body to define a crimp that extends into the inner cavity in order to retain the fluid flow restricting member in the inner cavity of the body;
flaring the wall of the body to define an outwardly flared portion that extends away from the inner cavity, the flaring step being performed after the crimping step, the fluid flow restricting member reduces or prevents fluid flow through the inner cavity.
